(19) United States
(12) Patent Application Publication
(10) Pub. No.: US 2017/0130365 A1
(43) Pub. Date: May 11, 2017

(54) NANOSTRUCTURED ENERGY HARVESTING MATERIAL MANUFACTURING SYSTEM

(71) Applicant: Yong X. Gan, Diamond Bar, CA (US)

(72) Inventor: Yong X. Gan, Diamond Bar, CA (US)

(73) Assignee: California State Polytechnic University, Pomona, Pomona, CA (US)

(21) Appl. No.: 14/936,914

(22) Filed: Nov. 10, 2015

(51) Int. Cl. D01D 5/00; B29C 47/08; B29C 47/00

(52) U.S. Cl. CPC D01D 5/0069; B29C 47/0076; B29C 47/0898; B29K 2995/0062

(57) ABSTRACT

The present invention discloses a nanostructured materials processing and manufacturing apparatus comprising a coaxial needle, a rotating disk, two spring pushers, and a electric power source with sufficient voltage, The coaxial needle, which is capable of simultaneously delivering two different types of solutions, is connected to a rotating shaft coupler and tilted at an angle, preferably 2 to 5 degrees, with respect to the vertical direction relative to the surface of the rotating disk. A mechanical action to the solutions is added by the rotation of the slightly tilted coaxial needle. The coaxial needle is electrically connected to the positive electrode of a electric power source by a pad pushed by a spring pusher, which enables the solutions in the coaxial needle to be electrified. The rotating disk is connected to the negative electrode of the power source. Due to both mechanical and electric actions, the apparatus performs electrospraying and/or electrospinning functions. The apparatus may produce nanoparticles, nanofibers, microfibers by adjusting the processing parameters. The apparatus is capable of generating well-aligned nanofibers due to the rotation of the rotating disk. The nanostructured materials may have thermoelectric energy conversion property. The apparatus may also be used to electrospray solution into nanotube specimens for doping the nanotubes. The doped nanotubes demonstrate photovoltaic behavior and self-cleaning function.

### RELATED APPLICATION

This application claims the benefit of priority under 35 U.S.C. §119(e) to Provisional Application No. 62/079,803, filed on Nov. 14, 2014.

### INCORPORATION BY REFERENCE OF MATERIAL SUBMITTED ON A COMPACT DISC

Not Applicable.

### THE NAMES OF THE PARTIES To A JOINT RESEARCH AGREEMENT

Not applicable.

### STATEMENT REGARDING FEDERALLY SPONSORED RESEARCH OR DEVELOPMENT

This invention described herein was made in the course of work supported by National Science Foundation Grant Number CMMI 1333044.

### BACKGROUND OF THE INVENTION

### Field

The invention relates to the application of nanostructured energy conversion materials and the manufacturing system. By applying external fields (electric or magnetic) to a nanocasting manufacturing system, the result would allow for the manufacture of multi-component organic/inorganic composite materials containing nanotubes, nanofibers and nanoparticles by external force (for instance electromagnetic force) assisted centrifugal nanocasting. The manufactured composite materials would possess high performance characteristics for self-cleaning, photovoltaic and thermoelectric energy conversions. More specifically, this invention relates to a nanostructured energy harvesting material manufacturing system, or a nanostructured material processing apparatus that can perform electrospraying, electrospinning to produce nanoparticles, nanofibers with photovoltaic, thermoelectric and self-cleaning properties. More particularly, the invention relates to generating oriented nanofibers under mechanical and electric actions.

### Description of Related Art Including Information Disclosed Under 37 C.F.R. 1.97 and 1.98

Nanomaterials processing and manufacturing is an important field with significant commercial value. Nanomaterials have found many applications in energy, biomedical, and environment protection related fields. There are various types of nanomaterials including nanoparticles, nanofibers, and nanotubes. Nanomaterials can be made by various methods including electrical, chemical, or electrochemical approaches. Electrospinning is a process for generating nanofibers under the action of a high voltage. However, the problem with electrospinning is that the fiber is oriented randomly, and the size of the produced fiber is within a small range of variation, for example from several tens of nanometers to several hundreds of nanometers. Moreover, the processing and manufacturing cost for nanomaterials is high.

Several processes for electrospinning nanofibers had been introduced in recent years. However, those processes have drawbacks. U.S. Pat. No. 9,005,510 discloses a process for producing polymer fibers by electrospinning using a syringe that injects water insoluble polymer and colloidal dispersions. The syringe disclosed therein is a syringe pump connected to a power source, which can only generate randomly oriented fiber products. U.S. Pat. No. 9,028,565 discloses a method and apparatus for making polymer fibers containing ceramic particles. The disclosed apparatus cannot align the fibers either. U.S. Pat. No. 9,011,754 discloses a device for manufacturing three-dimensional electrospun scaffolds using electrospinning. This device includes at least one spinneret connected to at least one container and a collector that is rotatable around at least one axis. However, controlling the orientation of fiber is not considered. None of the devices described above has the capability of providing controlled material shape, size, and orientation. Therefore, there is a need to provide a multifunctional, cost effective system that can produce nanoparticles, nanofibers, microfibers, aligned fibers, and nanoparticle-containing composite materials in a simple way.

### Brief Summary of the Invention

It is an objective of this invention to provide a nanomaterial processing apparatus that can be easily operated under the mechanical, electric and/or magnetic actions.

It is a further objective of this invention to provide such an apparatus that can easily control the size, shape, orientation of the manufactured products.

It is a further objective of this invention to provide such an apparatus that has electrospraying function to cast droplets into nanotubes. The nanotubes can be doped by the chemicals in the droplets. The processed nanomaterials have photovoltaic property and self-clean property due to the photoactive nanotubes.

It is a further objective of this invention to provide such an apparatus that is able to produce microfibers for thermoelectric energy conversion applications.

It is a further objective of this invention to provide such an apparatus that allows composite fiber formation when two different solutions are injected simultaneously from a co-axial needle.

These and other objectives are preferably accomplished by providing an apparatus comprising a coaxial needle connected to a rotating shaft, a rotating disk functioning as a collector, a direct current (DC) power source, and an electrical connector. The coaxial needle can deliver two different solutions through two different internal channels. The rotating shaft is capable of moving in circular direction and is aligned in a way so that there is a tilt angle with respect to the vertical direction relative to the surface of the rotating disk. This tilt angle allows the tip of the coaxial needle to deliver the solutions under the mechanical action (centrifuge force). The DC power source provides electrospraying and electrospinning effects. Nanoparticles can be generated by electrospraying. Nanofibers and microfibers can be produced through the electrospinning. Nanostructured materials manufactured by the apparatus may be photoactive or may have thermoelectric property.

These and other aspects of this invention will become apparent to those skilled in the art after reviewing the following description of the invention.

### BRIEF DESCRIPTION OF THE SEVERAL VIEWS OF THE DRAWINGS

The above-mentioned features and objects of the present disclosure will become more apparent with reference to the following description taken in conjunction with the accompanying drawings and images wherein like reference numerals denote like elements and in which:

FIG. 1 is a front perspective view of one embodiment of the present invention;

FIG. 2 is a scanning electron microscopic image of the nanofibers made using the present invention from which the well-aligned fibers can be seen.

FIG. 3 illustrates a nanotube sample being doped through electrospraying solution or casting the solution into the inside wall of the nanotubes.

FIGS. 4(a) to 4(c) illustrate the photovoltaic property of a nanotube material with dopants.

FIG. 5 illustrates the thermoelectric property of a polyaniline nanofiber product.

### DETAILED DESCRIPTION OF THE INVENTION

For illustrative purpose, the principles of the present invention are described by referring to an exemplary embodiment thereof. Before any embodiment of the invention is explained in detail, it should be understood that the invention is not limited in its application to the details of construction and the arrangement of components set forth in the following description or illustrated in the following drawings. The invention is capable of other embodiments and of being practiced or of being carried out in various ways. Also, it should be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

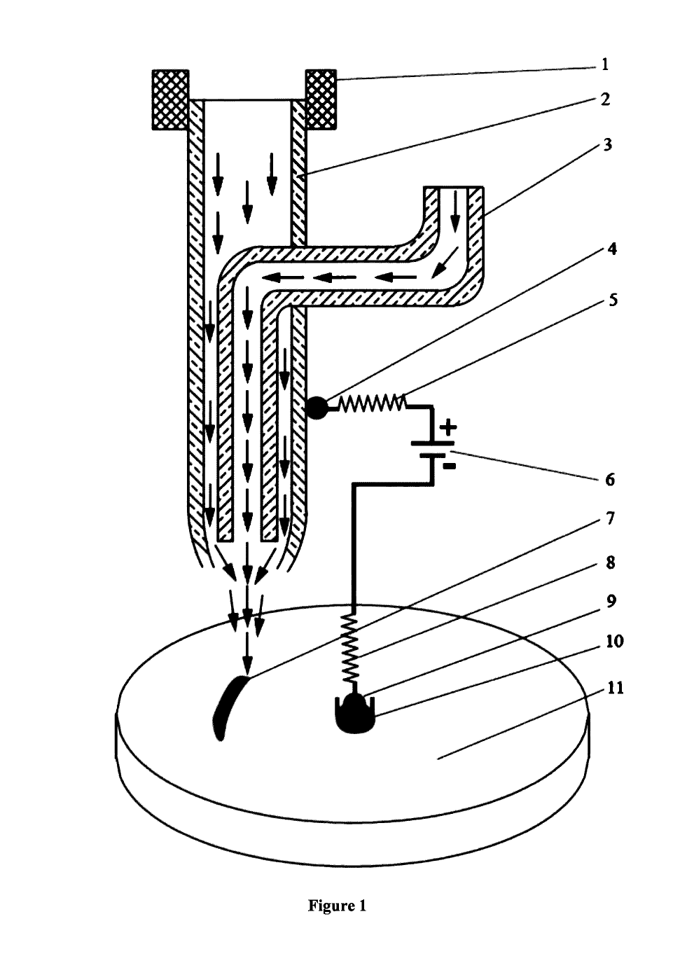

Referring to FIG. 1 of the drawing, the outside layer of a coaxial needle 2 is connected to a tilted rotating shaft through a coupler 1. The coaxial needle is made from electrically conductive material. The coaxial needle comprises an inner tube and an outer tube. The outer tube of the coaxial needle serves to deliver one solution, and inner tube 3 serves to deliver another solution. An electrically conductive pad 4 connected with an electrically conductive spring 5 maintains contact with the outside wall of the coaxial needle. This allows the coaxial needle to be electrically connected with the positive electrode of the direct current (DC) power source 6 of sufficient voltage. The voltage applied may vary in a broad range. For typical operations, a voltage of 15 kilovolts (kV) is used. The voltage electrifies the solutions delivered by the coaxial needle, which enables the formation of electrospraying or electrospinning product 7. The negative electrode of the power source is connected to another electrically conductive spring 8. At the other end of this spring, an electrically conductive pad 9, which is housed in a shaft coupler 10, is connected thereto. The electrically conductive pads (4 and 9) may be made of graphite or any other electrically conductive material. Through the electrically conductive pad 9 and spring 8, the rotating disk 11 is electrically connected with the negative electrode of the DC power source.

As shown in FIG. 1, due to the different chemical compositions of the two solutions, composite nanomaterials can be processed. One of the delivery channels, i.e., the inner tube or the outer tube, in the coaxial needle can be filled with solid powders or nanoparticles. The nanoparticles can be added into the solution from the other delivery channel and form composite materials through the subsequent electrospraying or electrospinning. Through the rotation motion of the rotating disk 11, the nanofiber product 7 from electrospraying or electrospinning can be aligned.

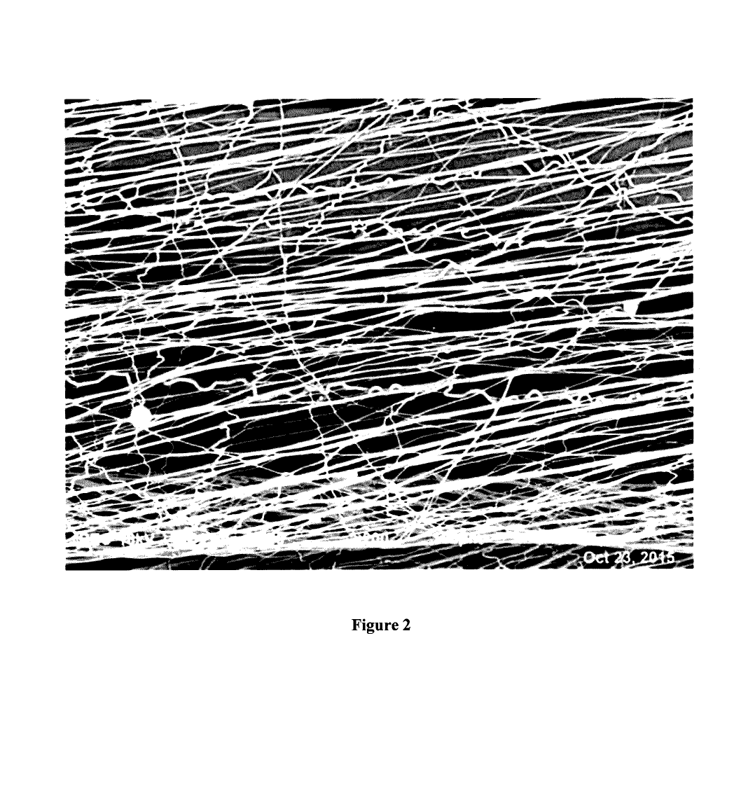

FIG. 2 is a scanning electron microscopic image of polyvinylpyrrolidinone (PVP) nanofibers containing titanium dioxide nanoparticles processed using the apparatus described above. As shown, the fiber orientation is well-aligned through the use of the present invention.

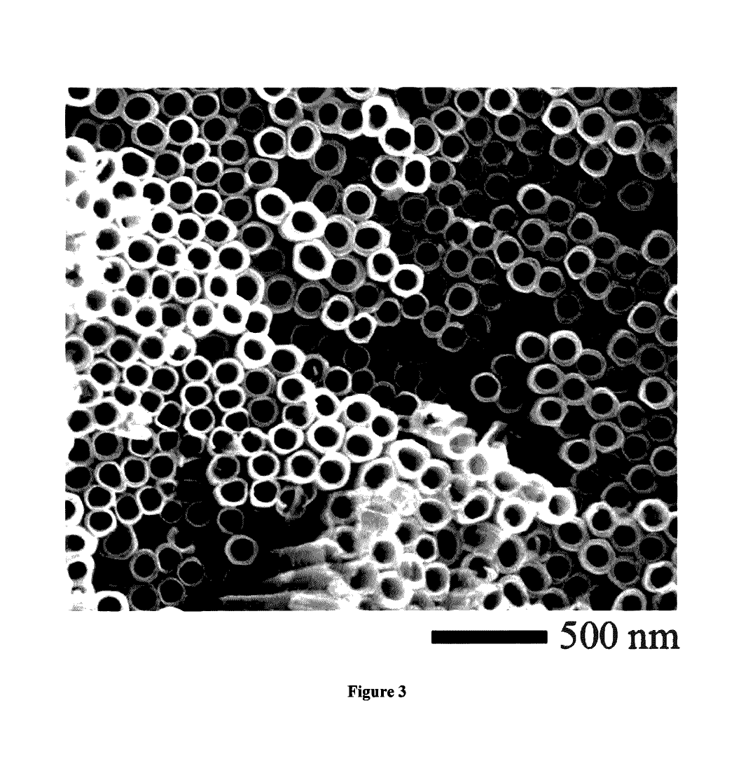

FIG. 3 shows a titanium nanotube that is doped with electrosprayed chemicals using the apparatus described above.

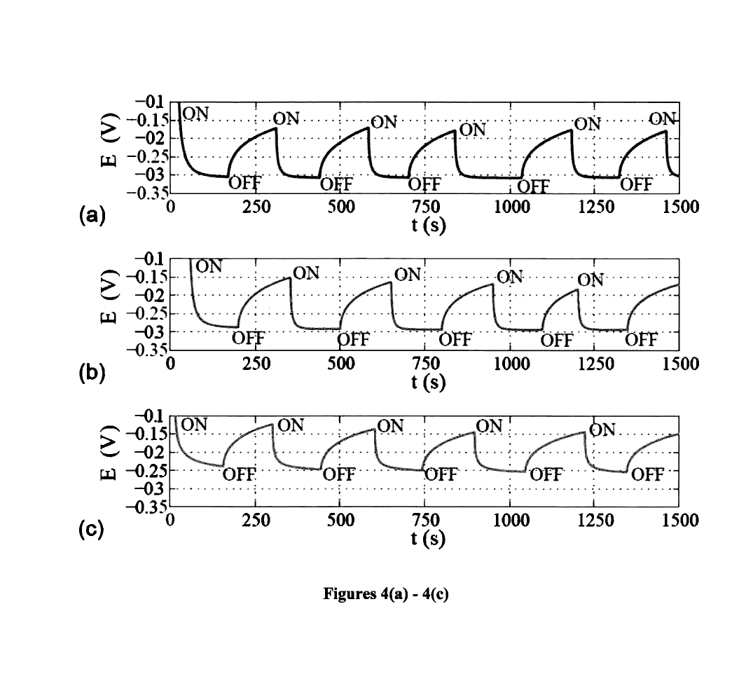

FIGS. 4(a) to 4(c) illustrate the photovoltaic property of the doped titanium nanotube. The doping is accomplished using the apparatus described in accordance with FIG. 1. In a typical operation, cobalt acetate was electrosprayed into titanium dioxide nanotube followed by heat treatment. After heat treatment, the specimen was used as the working electrode for photovoltaics test under the shinning of ultraviolet (UV) light. The voltage across the working electrode and a reference electrode was recorded. FIGS. 4(a), 4(b) and 4(c) show the open circuit potential (E) versus time (t) curves obtained from the tests on the solutions containing 1.25 wt %, 0.625 wt % and 0.05 wt % ammonia, respectively. The UV light source can be switched to ON or OFF states. FIGS. 4(a), (b) and (c) show that when the light is ON, the voltage at the photosensitive anode drops. For the solution with 1.25% ammonia solution, the voltage dropped to as low as −0.35 V. The change in the potential is approximately 0.31 V. For the solution with ammonia concentration of 0.625%, the voltage dropped to the lowest value of −0.3 V. The change in the potential is approximately 0.26 V. Finally, for the solution with ammonia concentration of 0.05%, the voltage dropped to the lowest value of −0.25 V and the Change in the potential is approximately 0.19 V.

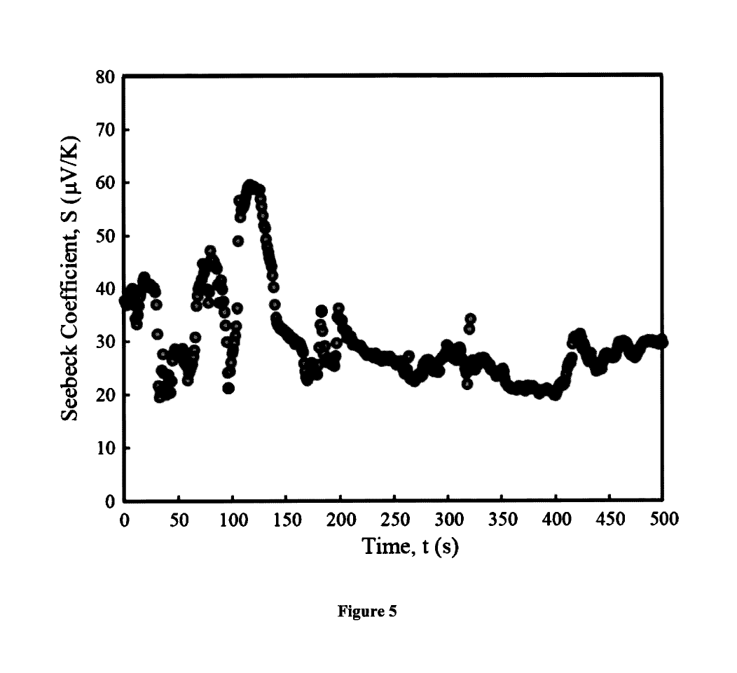

FIG. 5 illustrates the thermoelectric behavior of a polyaniline nanofiber made by using the apparatus described in accordance with FIG. 1. Seebeck coefficient is a measure of the magnitude of an induced thermoelectric voltage in response to a temperature difference across a material, as induced by the Seebeck effect. As shown in FIG. 5, the stable absolute value of Seebeck coefficient for the polyaniline nanofiber is about 30 μV/K. The material shows n-type behavior. In comparison with inorganic semiconducting material, such as bulky silicon crystalline material, the polyaniline nanofiber has a lower value of Seebeck coefficient. The measured Seebeck value for bulky silicon material may be as high as 40 μV/K under the same measurement condition. As shown, the Seebeck coefficient is the time dependent at the initial stage. This is because with the transient heat conduction at the moment of contact, the effective temperature difference fluctuates at the beginning. The heat induced electron ejection behavior stabilizes after several minutes. Therefore the measured Seebeck coefficient changes with time. After three minutes, the absolute values of the Seebeck coefficient become stable as shown in FIG. 5.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

1. Nanostructured material manufacturing apparatus comprising:
a coaxial needle, a rotating disk collector, a rotating shaft, and a voltage power source;
the coaxial needle comprising an inner portion and an outer portion, the inner portion is configured to allow the passage of a first solution and the outer portion is configured to allow the passage of a second solution;
the rotating disk collector comprising a surface and the surface is configured to collect products formed from the electrospraying or electrospinning of the first and/or second solutions delivered from the coaxial needle;
the coaxial needle is configured to connect to the rotating shaft and is tilted at an angle with respect to the vertical direction relative to the surface of the rotating disk collector, the rotating shaft is configured to generate a centrifugal force to facilitate the passage of the first and/or second solutions;
the voltage power source is configured to provide voltage to electrify the first and/or second solutions, and is electrically connected to the coaxial needle and the rotating disk collector.

2. The nanostructured materials manufacturing apparatus of claim 1 wherein the voltage power source is electrically connected to the coaxial needle and the rotating disk collector through one or more electrically conductive pads.

3. The nanostructured materials manufacturing apparatus of claim 2 wherein the one or more electrically conductive pads are made of graphite.

4. The nanostructured materials processing apparatus of claim 1 wherein the voltage of the voltage power source is approximately 15 kilovolts.

5. The nanostructured materials processing apparatus of claim 1 wherein the coaxial needle is configured to tilt at an angle between 2 to 5 degrees with respect to the vertical direction relative to the surface of the rotating disk collector.

6. The nanostructured materials processing apparatus of claim 1 wherein the first solution comprising titanium dioxide, polyaniline dissolved in organic solvent NMP (1-methyl-2-pyrrolidinone), cobalt acetate, or other metal salts dissolved in a polyvinylpyrrolidinone (PVP) ethanol solution.

7. The nanostructured materials processing apparatus of claim 1 wherein the second solution comprising titanium dioxide, polyaniline dissolved in organic solvent NMP (1-methyl-2-pyrrolidinone), cobalt acetate, or other metal salts dissolved in a polyvinylpyrrolidinone (PVP) ethanol solution.
